(19) United States
(12) Patent Application Publication
(10) Pub. No.: US 2023/0150115 A1
(43) Pub. Date: May 18, 2023

(54) APPARATUS FOR ASSISTING MUSCULAR STRENGTH

(71) Applicants: Hyundai Motor Company, Seoul (KR); Kia Corporation, Seoul (KR)

(72) Inventors: Ki Hyeon Bae, Hwaseong (KR); Sang In Park, Suwon (KR); Ju Young Yoon, Suwon (KR); Kyu Jung Kim, Seoul (KR); Min Woong Jeung, Seoul (KR); Hyo Joong Kim, Suwon (KR); Seong Taek Hwang, Suwon (KR); Ho Jun Kim, Gunpo (KR); Hyun Seop Lim, Anyang (KR); Beom Su Kim, Yongin (KR)

(21) Appl. No.: 17/892,060

(22) Filed: Aug. 20, 2022

(30) Foreign Application Priority Data
Nov. 15, 2021 (KR) 10-2021-0156942

(51) Int. Cl. B25J 9/00

(52) U.S. Cl. CPC B25J 9/0006

(57) ABSTRACT

Disclosed is an apparatus for assisting muscular strength, the apparatus including: an upper frame configured to be fixed to a user's upper body; a lower frame disposed below the upper frame and configured to be fixed to the user's lower body and rotatable relative to the upper frame; a wire disposed across the upper frame and the lower frame; and a force generating unit coupled to one side of the upper frame, in which when the lower frame rotates in a first direction D1 relative to the upper frame, the force generating unit generates a force applied in a second direction D2 opposite to the first direction D1, in which the force generating unit includes: a first movable member; a second movable member; and a main spring part.

### CROSS-REFERENCE TO RELATED APPLICATION

This application claims under 35 U.S.C. § 119(a) the benefit of Korean Patent Application No. 10-2021-0156942 filed on Nov. 15, 2021, the entire contents of which are incorporated herein by reference.

### BACKGROUND

### (a) Field

The present disclosure relates to an apparatus for assisting muscular strength, and more particularly, an apparatus for assisting muscular strength of a user's waist muscles.

### (b) Description of Related Art

An apparatus for assisting strength of waist muscles, which is capable of assisting strength of a user's waist muscles while the user works, generates torque by applying elasticity to body portions in the vicinity of rotatable joints such as hip joints, thereby reducing a load applied to the user's waist during the work process.

In general, such an apparatus for assisting strength of waist muscles often has structures disposed at two left and right sides of the apparatus and configured to generate torque. In this case, the apparatus for assisting muscular strength may broadly have Feature i) in which the two structures are connected to each other and the motions of the two structures are performed in conjunction with each other, or Feature ii) in which the two structures are provided independently of each other and the motions of the two structures are performed independently of each. In the case in which the apparatus for assisting strength of waist muscles has Feature i), the apparatus is sometimes designed such that the apparatus generates torque for assisting muscular strength when the two structures rotate in the same direction (e.g., the user bends his/her waist), whereas the apparatus does not generate torque for assisting muscular strength when the two structures rotate in the opposite directions (e.g., the user walks).

Meanwhile, in the related art, the apparatus for assisting strength of waist muscles includes main components positioned to apply torque to the user's back. However, in this case, because the main components often have structures protruding rearward, the user often cannot easily sit in a chair having a backrest while the user wears the apparatus for assisting strength of waist muscles.

### SUMMARY

In exemplary embodiments, the present disclosure provides for an apparatus for assisting the strength of waist muscles, wherein the structure of the apparatus is configured to enable a user to sit in a chair having a backrest while the user wears the apparatus.

An exemplary embodiment of the present disclosure provides an apparatus for assisting muscular strength, the apparatus including: an upper frame configured to be fixed to a user's upper body; a lower frame disposed below the upper frame and configured to be fixed to the user's lower body and rotatable relative to the upper frame; a wire disposed across the upper frame and the lower frame; and a force generating unit coupled to one side of the upper frame, whereby when the lower frame rotates in a first direction D1 relative to the upper frame, the force generating unit applies a force to the lower frame in a second direction D2 opposite to the first direction D1, in which the force generating unit includes: a first movable member configured to be movable in an upward/downward direction H; a second movable member disposed below the first movable member and configured to be movable in the upward/downward direction H; and a main spring part having one side fixed to the first movable member and the other side fixed to the second movable member.

The force generating unit may further include first pulley members fixed to one side of the second movable member, and the wire may extend upward from the lower frame, surround upper portions of the first pulley members, and then extend downward toward the lower frame.

The lower frame may include second pulley members coupled to be rotatable relative to the upper frame, and ends of the wire may be fixed to the second pulley members.

The lower frame may further include: a right lower frame configured to be fixed to the user's right leg; and a left lower frame configured to be fixed to the user's left leg, the second pulley members may be respectively disposed on the right and left lower frames, and one end of the wire may be fixed to the second pulley member disposed on the right lower frame, and the other end of the wire, which is opposite to one end of the wire, may be fixed to the second pulley member disposed on the left lower frame.

The upper frame may include: an up/down extension region extending in the upward/downward direction H and coupled to the force generating unit; a right extension region extending in a right direction from a lower portion of the up/down extension region and connected to the right lower frame by means of the second pulley member; and a left extension region extending in a left direction from the lower portion of the up/down extension region and connected to the left lower frame by means of the second pulley member.

The main spring part may include a first main spring part having one end coupled to an upper end region of the first movable member and the other end coupled to an upper end region of the second movable member.

The main spring part may further include a second main spring part having one end coupled to a lower end region of the first movable member and the other end coupled to a lower end region of the second movable member.

The lower end region of the first movable member may be disposed between the upper end region of the second movable member and the lower end region of the second movable member.

The first main spring part or the second main spring part may include a plurality of spring members.

An elastic modulus of the first main spring part may correspond to an elastic modulus of the second main spring part.

The up/down extension region may further include a latch member having a lower region configured to be rotatable about an upper region of the latch member, and the lower region of the latch member may be coupled to or separated from the first movable member according to a rotation of the latch member.

The first movable member may include a recessed portion recessed in a forward/rearward direction, and the latch member may include a protrusion configured to be inserted into the recessed portion or separated from the recessed portion according to the rotation of the latch member.

The force generating unit may further include an auxiliary spring part having one end coupled to the up/down extension region and the other end coupled to the first movable member.

An elastic modulus of the auxiliary spring part may be smaller than an elastic modulus of the first main spring part.

One end of the auxiliary spring part may be coupled to an upper end of the latch member, and the other end of the auxiliary spring part may be coupled to an upper end of the first movable member.

The wire may surround a lower region of the second pulley member disposed on the right lower frame and surround a lower region of the second pulley member disposed on the left lower frame.

The apparatus may further include: a harness coupled to one side of the upper frame, in which the harness includes: a first surrounding member configured to surround the user's chest; a plurality of second surrounding members configured to surround the user's shoulders; and a handle member having one side configured to extend forward across the user's the shoulders and the other side connected to the upper region of the latch member, and when one side of the handle member is pulled forward, the upper region of the latch member may be rotated, such that the lower region of the latch member is rotated rearward.

The upper frame may further include third pulley members respectively fixed to the right and left extension regions, and the wire may surround lower regions of the third pulley members and then extend upward toward the first pulley members.

The first and second movable members may each have a shape having a penetrated central region.

Embodiments of the present disclosure are directed to an apparatus for assisting strength of waist muscles that has a structure configured to enable a user to sit in a chair having a backrest while the user wears the apparatus.

### BRIEF DESCRIPTION OF THE DRAWINGS

The accompanying drawings, which are incorporated herein and constitute part of this specification, are illustrative of particular embodiments of the present disclosure and do not limit the scope of the present disclosure.

FIG. 1 is a rear view illustrating a state in which a user wears an apparatus for assisting muscular strength according to an example embodiment of the present disclosure.

FIG. 2 is a side view illustrating a state in which the user wears the apparatus for assisting muscular strength according to an example embodiment of the present disclosure.

FIG. 3 is a view illustrating a structure for coupling an upper frame and a force generating unit of the apparatus for assisting muscular strength according to an example embodiment of the present disclosure.

FIG. 4 is an enlarged view of a harness of the apparatus for assisting muscular strength according to an example embodiment of the present disclosure.

FIG. 5 is a perspective view illustrating a state in which the upper frame is connected to the force generating unit by means of a latch member in the apparatus for assisting muscular strength according to an example embodiment of the present disclosure.

FIG. 6 is a perspective view illustrating a state in which the upper frame and the force generating unit, which have been connected by means of the latch member, are disconnected from each other in the apparatus for assisting muscular strength according to an example embodiment of the present disclosure.

FIG. 7 is a view illustrating the relative positional relationships between components of the force generating unit and the apparatus for assisting muscular strength before the user wears the apparatus for assisting muscular strength according to an example embodiment of the present disclosure.

FIG. 8 is a view illustrating the relative positional relationships between the components of the force generating unit and the apparatus for assisting muscular strength immediately after the user wears the apparatus for assisting muscular strength according to an example embodiment of the present disclosure.

FIG. 9 is a view illustrating the relative positional relationships between the components of the force generating unit and the apparatus for assisting muscular strength when the user bends his/her waist in the state in which the user wears the apparatus for assisting muscular strength according to an example embodiment of the present disclosure.

FIG. 10 is a view illustrating the relative positional relationships between the components of the force generating unit and the apparatus for assisting muscular strength in the state in which the user wears the apparatus for assisting muscular strength according to an example embodiment of the present disclosure and in which the latch member and the force generating unit are disconnected from each other.

FIG. 11 is a view illustrating the relative positional relationships between the components of the force generating unit and the apparatus for assisting muscular strength when the user bends the waist in the state in which the user wears the apparatus for assisting muscular strength according to an example embodiment of the present disclosure and in which the latch member and the force generating unit are disconnected from each other.

### DETAILED DESCRIPTION

The above and other objects, features and advantages of embodiments of the present disclosure will be more apparent from the following detailed description taken in conjunction with the accompanying drawings. The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

according to an example embodiment of the present disclosure Apparatus for Assisting Muscular Strength

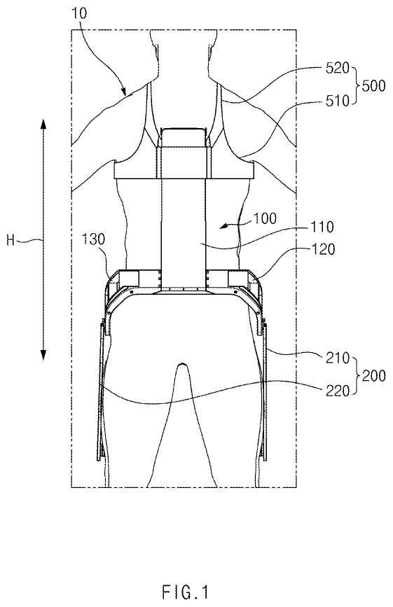

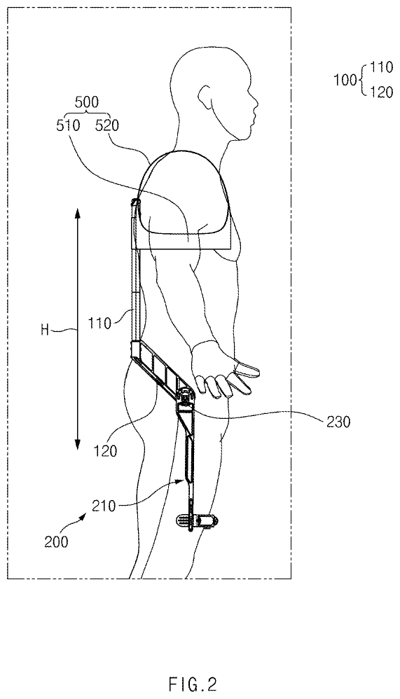

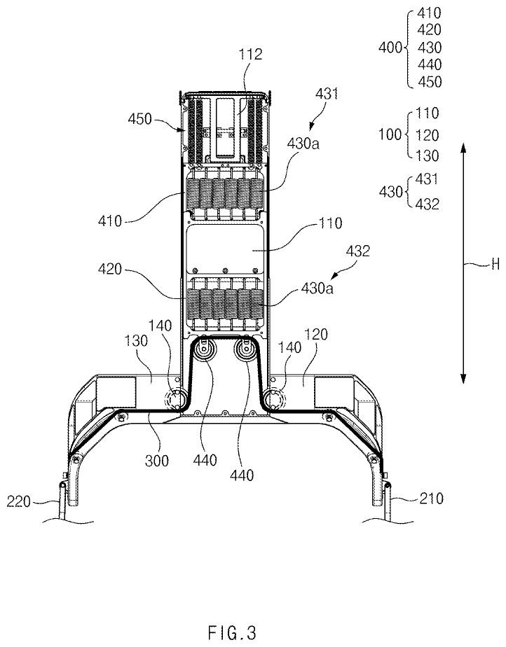

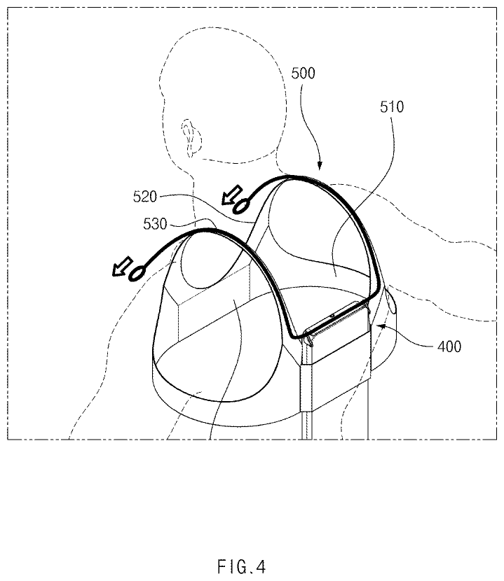

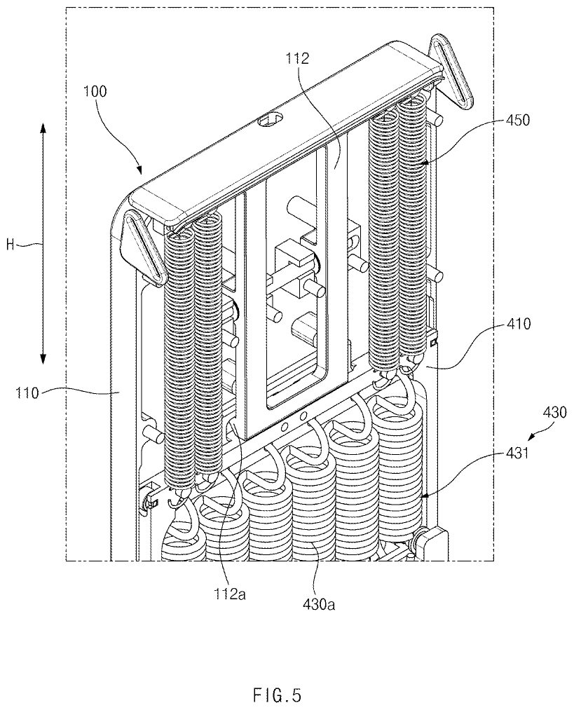

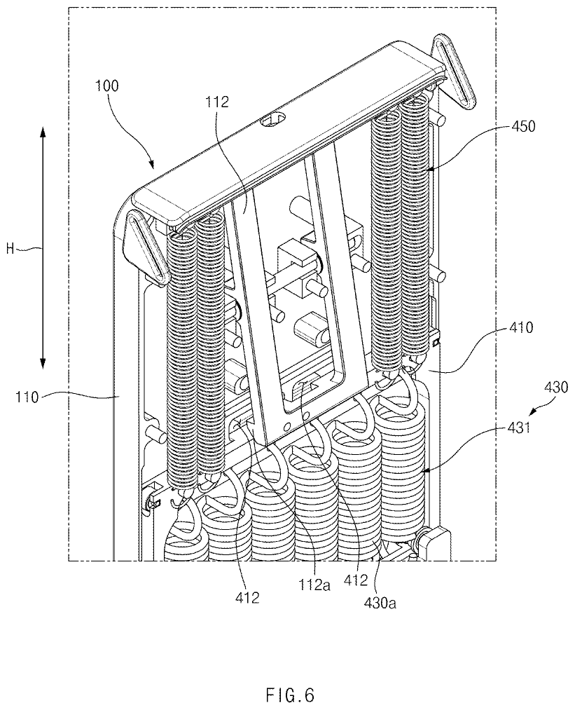

FIG. 1 is a rear view illustrating a state in which a user wears an apparatus for assisting muscular strength according to an example embodiment of the present disclosure, and FIG. 2 is a side view illustrating a state in which the user wears the apparatus for assisting muscular strength according to an example embodiment of the present disclosure. FIG. 3 is a view illustrating a structure for coupling an upper frame and a force generating unit of the apparatus for assisting muscular strength according to an example embodiment of the present disclosure, and FIG. 4 is an enlarged view of a harness of the apparatus for assisting muscular strength according to an example embodiment of the present disclosure. In addition, FIG. 5 is a perspective view illustrating a state in which the upper frame is connected to the force generating unit by means of a latch member in the apparatus for assisting muscular strength according to an example embodiment of the present disclosure, and FIG. 6 is a perspective view illustrating a state in which the upper frame and the force generating unit, which have been connected by means of the latch member, are disconnected from each other in the apparatus for assisting muscular strength according to an example embodiment of the present disclosure.

The apparatus 10 for assisting muscular strength may be configured to generate a force for assisting strength of a user's waist muscles. For example, when the user bends his/her waist, the apparatus 10 for assisting muscular strength may be configured to reduce a load applied to the user's waist by generating the force in the direction in which the user's waist is stretched. In addition, the user may optionally operate the apparatus for assisting muscular strength so that the apparatus does not generate the force even though the user bends his/her waist while the user wears the apparatus. Thus, the user may take postures, for example, sitting in a chair or on a floor without taking off the apparatus for assisting muscular strength.

Referring to FIGS. 1 and 2, the apparatus 10 for assisting muscular strength according to an example embodiment of the present disclosure may include: an upper frame 100 configured to be fixed to the user's upper body; a lower frame 200 disposed below the upper frame 100 and configured to be fixed to the user's lower body and rotatable relative to the upper frame 100; and a wire 300 disposed across the upper frame 100 and the lower frame 200. Since the lower frame 200 is rotatable relative to the upper frame 100, the user may walk or bend his/her waist while the user wears the apparatus 10 for assisting muscular strength. Meanwhile, as described below, according to an example embodiment of the present disclosure tension may be applied to the wire 300, such that the apparatus 10 for assisting muscular strength provides the force for assisting the strength of the user's waist muscles. Meanwhile, in the present specification and the drawings, for the convenience of description, the relative rotational motions between the upper frame 100 and the lower frame 200 will be described on the basis of a direction in which the lower frame 200 rotates relative to the upper frame 100.

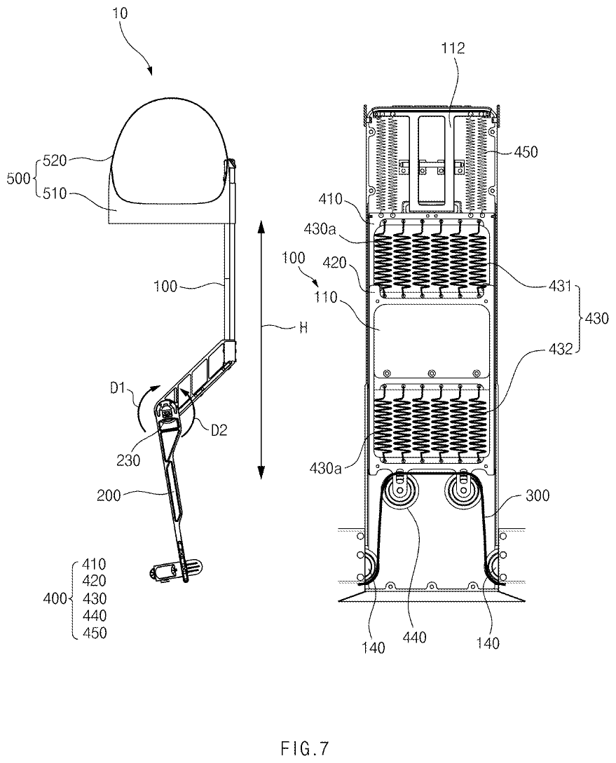

Referring to FIGS. 1 to 3, the apparatus 10 for assisting muscular strength according to an example embodiment of the present disclosure may further include a force generating unit 400 coupled to one side of the upper frame 100 and configured to generate the force for assisting the strength of the user's waist muscles. In more detail, when the lower frame 200 rotates in a first direction D1 (see FIGS. 7 to 11) relative to the upper frame 100, the force generating unit 400 may be configured to apply the force to the lower frame 200 in a second direction D2 (see FIGS. 7 to 11) opposite to the first direction. This configuration may mean that when the user bends his/her waist in the state in which the user wears the apparatus 10 for assisting muscular strength, the force generating unit 400 applies the force in a direction in which the waist is stretched. Therefore, when the user bends his/her waist in the state in which the user wears the apparatus 10 for assisting muscular strength, the user may supplementarily receive the force in the direction in which the waist is stretched.

The force generating unit 400 may have a structure in which at least some components of the force generating unit 400 may be configured to be moved in an upward/downward direction H, and the tension of the wire 300 may be changed, thereby changing the force capable of assisting the strength of the waist muscles.

Referring to FIG. 3, the force generating unit 400 may include: a first movable member 410 configured to be movable in the upward/downward direction H; a second movable member 420 disposed below the first movable member 410 and configured to be movable in the upward/downward direction H; and a main spring part 430 having one side fixed to the first movable member 410 and the other side fixed to the second movable member 420. Therefore, according to an example embodiment of the present disclosure, as the first and second movable members 410 and 420 are moved in the upward/downward direction H, the deformation amount of the main spring part 430 may be changed, such that the tension of the wire 300 may also be changed.

For example, the first and second movable members 410 and 420 may each have a shape having a penetrated central region. Therefore, it is possible to minimize weights of the first and second movable members 410 and 420. FIG. 3 illustrates the first and second movable members 410 and 420 each have an approximately quadrangular shape and a penetrated central region.

The force generating unit 400 may further include first pulley members 440 fixed to one side of the second movable member 420. For example, as illustrated in FIG. 3, the first pulley members 440 may be fixed to an end of a lower portion of the second movable member 420. In this case, the wire 300 may extend upward from the lower frame 200, surround upper portions of the first pulley members 440, and then extend downward toward the lower frame 200.

According to an example embodiment of the present disclosure, when the second movable member 420 moves downward, the first pulley members 440 may also move downward, such that the wire 300 may also move downward. On the contrary, when the second movable member 420 moves upward, the first pulley members 440 and the wire 300 may also move upward. The upward or downward movement of the second movable member 420 may be initiated by a force of the wire 300 that pulls the second movable member 420 downward. That is, the upward or downward movement of the second movable member 420 may be initiated by the tension of the wire 300.

Meanwhile, referring to FIG. 3, the lower frame 200 may include second pulley members 230 coupled to be rotatable relative to the upper frame 100, and the ends of the wire 300 may be fixed to the second pulley members 230.

According to an example embodiment of the present disclosure, when the lower frame 200 rotates relative to the upper frame 100, the wire 300 may be wound around or unwound from the second pulley members 230. Therefore, the first pulley members 440 are moved upward or downward by interference between the wire 300 and the first pulley members 440. When the first pulley members 440 are moved upward or downward, the second movable member 420 connected to the first pulley members 440 is also moved in the upward/downward direction H, and the first movable member 410 connected to the second movable member 420 by means of the main spring part 430 is also moved in the upward/downward direction H. In this case, when a distance in the upward/downward direction H between the first movable member 410 and the second movable member 420 is changed, the deformation amount of the main spring part 430 is changed, and the tension applied to the wire 300 is changed depending on a change in elastic force of the main spring part 430. Therefore, according to an example embodiment of the present disclosure, the torque, which is applied by the wire 300 to rotate the second pulley members 230, is changed by the change in tension applied to the wire 300, which generates the force for assisting the strength of the user's waist muscles.

Referring to FIG. 3, the lower frame 200 may further include a right lower frame 210 configured to be fixed to the user's right leg, and a left lower frame 220 configured to be fixed to the user's left leg. In this case, the second pulley members 230 may be respectively disposed on the right and left lower frames 210 and 220. In addition, the wire 300 may surround a lower region of the second pulley member 230 disposed on the right lower frame 210, and a lower region of the second pulley member 230 disposed on the left lower frame 220. This is to allow the wire 300 to be wound around the second pulley members 230 when the right and left lower frames 210 and 220 rotate in a direction toward the upper frame 100, i.e., when the second pulley members 230 rotate in the first direction D1. In this case, as the wire 300 is wound around the second pulley members 230, the wire 300 pulls the second movable member 420 downward, such that the deformation amount of the main spring part 430 is increased, and thus the tension applied to the wire 300 is increased. Therefore, the wire 300 pulls the second pulley members 230 in the second direction D2.

In addition, one end of the wire 300 may be fixed to the second pulley member 230 disposed on the right lower frame 210, and the other end of the wire 300, which is opposite to one end of the wire 300, may be fixed to the second pulley member 230 disposed on the left lower frame 220. Therefore, when both the right and left lower frames 210 and 220 rotate in the direction toward the upper frame 100, i.e., when the second pulley members 230 rotate in the first direction D1, the wire 300 is wound around the second pulley members 230 while the second pulley members 230 rotate, such that the tension of the wire 300 increases. The wire 300 with the increased tension pulls the force generating unit 400 downward by means of the first pulley members 440, and the deformation amount of the main spring part 430 also increases. Therefore, the force for assisting the strength of the user's waist muscles, i.e., the force, which rotates the user's waist in a direction in which the user's waist is stretched, is increased. As will be described below, this configuration may indicate that when the user bends his/her waist, the force for assisting the strength of the user's waist muscles, i.e., the force, which is applied in the direction opposite to the direction in which the waist is bent, is increased.

Meanwhile, as illustrated in FIG. 3, the upper frame 100 may include: an up/down extension region 110 extending in the upward/downward direction H and coupled to the force generating unit 400; a right extension region 120 extending in a right direction from a lower portion of the up/down extension region 110 and connected to the right lower frame 210 by means of the second pulley member 230; and a left extension region 130 extending in a left direction from the lower portion of the up/down extension region 110 and connected to the left lower frame 220 by means of the second pulley member 230. In this case, the upper frame 100 may be understood as having an approximately upside-down T shape.

According to an example embodiment of the present disclosure, the main spring part 430 may include a plurality of main spring parts. In more detail, as illustrated in FIG. 3, the main spring part 430 may include a first main spring part 431 having one end coupled to an upper end region of the first movable member 410, and the other end coupled to an upper end region of the second movable member 420. The main spring part 430 may further include a second main spring part 432 having one end coupled to a lower end region of the first movable member 410, and the other end coupled to a lower end region of the second movable member 420.

In this case, as illustrated in FIG. 3, according to an example embodiment of the present disclosure, the lower end region of the first movable member 410 may be disposed between the upper end region of the second movable member 420 and the lower end region of the second movable member 420. It may be understood that the first movable member 410 is disposed above the second movable member 420 and the first movable member 410 and the second movable member 420 partially overlap each other in the upward/downward direction H. In this case, a length, which is occupied by the first and second movable members 410 and 420 in the upward/downward direction H, may be minimized, which makes it possible to minimize a size of the apparatus 10 for assisting muscular strength.

Meanwhile, according to an example embodiment of the present disclosure, the first main spring part 431 or the second main spring part 432 may include a plurality of spring members 430a. In more detail, the first and second main spring parts 431 and 432 may each include the plurality of spring members 430a connected in parallel with each other.

In this case, an elastic modulus of the first main spring part 431 and an elastic modulus of the second main spring part 432 may correspond to each other. In this case, the configuration in which the two elastic moduli correspond to each other may be interpreted not only as a configuration in which the two elastic moduli are equal to each other, but also as a configuration in which the two elastic moduli are different from each other to the extent that there is no substantially significant difference, in terms of the performance of the apparatus 10 for assisting muscular strength, from the configuration in which the two elastic moduli are equal to each other.

Referring to FIG. 3, the upper frame 100 may further include third pulley members 140 respectively fixed to the right and left extension regions 120 and 130. In this case, the wire 300 may surround lower regions of the third pulley members 140 and then extend upward toward the first pulley members 440. That is, according to an example embodiment of the present disclosure, the wire 300 may be shaped to i) extend from the second pulley member 230 disposed on the right lower frame 210 to the third pulley member 140 disposed on the right extension region 120, ii) surround the lower region of the third pulley member 140 disposed on the right extension region 120 and then extend upward, iii) surround upper regions of the first pulley members 440 and then extend downward, and iv) surround the lower region of the third pulley member 140 disposed on the left extension region 130 and then extend to the second pulley member 230 disposed on the left lower frame 220.

Meanwhile, according to an example embodiment of the present disclosure, the upper frame 100 and the force generating unit 400 may be selectively connected or disconnected by the user's manipulation. To this end, according to an example embodiment of the present disclosure, a latch structure may be rotatably provided.

In more detail, referring to FIG. 3, the up/down extension region 110 of the upper frame 100 may further include a latch member 112 having a lower region rotatable about an upper region of the latch member 112. The latch member 112 may face the first movable member 410. In more detail, the apparatus 10 for assisting muscular strength may be configured such that the lower region of the latch member 112 may be coupled to or separated from the first movable member 410 according to the rotation of the latch member 112.

More particularly, the first movable member 410 may include a recessed portion 412 recessed in a forward/rearward direction. In this case, the recessed portion 412 may be a hole having a penetrated shape or a groove having a recessed shape. For example, FIG. 3 illustrates that the recessed portion 412 has a penetrated hole shape.

In addition, the latch member 112 may include a protrusion 112a protruding forward, and the protrusion 112a may be inserted into the recessed portion 412 or separated from the recessed portion 412 according to the rotation of the latch member 112. Therefore, according to an example embodiment of the present disclosure, the up/down extension region 110 and the first movable member 410 may be coupled to each other by the interference between the protrusion 112a and the recessed portion 412 when the protrusion 112a is inserted into the recessed portion 412. The up/down extension region 110 and the first movable member 410 may be disconnected from each other when the protrusion 112a is separated from the recessed portion 412. Meanwhile, FIGS. 5 and 6 illustrate an example in which the protrusion 112a protrudes forward from the latch member 112 and the latch member 112 is able to be separated rearward from the first movable member 410 by rotating. In this case, the term “forward” means a direction in which the user is looking when the user wears the apparatus 10 for assisting muscular strength, and the term “rearward” means a direction opposite to the forward direction.

According to an example embodiment of the present disclosure, the force generating unit 400 may further include an auxiliary spring part 450 having one end coupled to the up/down extension region 110 and the other end coupled to the first movable member 410.

As described above, the main spring part 430 may be configured to provide the force for assisting the strength of the user's waist muscles. In contrast, the auxiliary spring part 450 may be configured to provide a predetermined close-contact force that enables the lower frame 200 to come into close contact with the user's lower body when the user wears the apparatus 10 for assisting muscular strength. In more detail, even when the latch member 112 and the first movable member 410 are decoupled from each other, the auxiliary spring part 450 may be configured to provide a predetermined force that allows the lower frame 200 to rotate away from the upper frame 100, thereby allowing the lower frame 200 to come into close contact with the user's lower body. For example, as illustrated in FIG. 3, one end of the auxiliary spring part 450 may be fixedly coupled to an upper end of the latch member 112, and the other end of the auxiliary spring part 450 may be fixedly coupled to an upper end of the first movable member 410.

Meanwhile, since the auxiliary spring part 450 only needs to provide the force for allowing the lower frame 200 to come into close contact with the user's lower body as described above, an elastic modulus of the auxiliary spring part 450 may be remarkably smaller than an elastic modulus of the first main spring part 431.

Meanwhile, referring to FIG. 4, the apparatus 10 for assisting muscular strength according to an example embodiment of the present disclosure may further include a harness 500 coupled to one side of the upper frame 100. The harness 500 may be configured to surround the user's chest and shoulders so that the user may more stably wear the apparatus 10 for assisting muscular strength.

For example, the harness 500 may include: a first surrounding member 510 configured to surround the user's chest; a plurality of second surrounding members 520 configured to surround the user's shoulders; and a handle member 530 having one side extending forward across the user's shoulders and the other side connected to the upper region of the latch member 112.

The handle member 530 may be configured to couple or decouple latch member 112 to or from the first movable member 410. In more detail, referring to FIGS. 5 and 6, when the user pulls one side of the handle member 530 forward, the upper region of the latch member 112 is rotated, such that the lower region of the latch member 112 may move rearward relative to the upper region which is a rotation axis. When the lower region of the latch member 112 is moved rearward, the first movable member 410 may be moved downward by the tension of the wire 300, such that the latch member 112 and the first movable member 410 may be moved away from each other in the upward/downward direction.

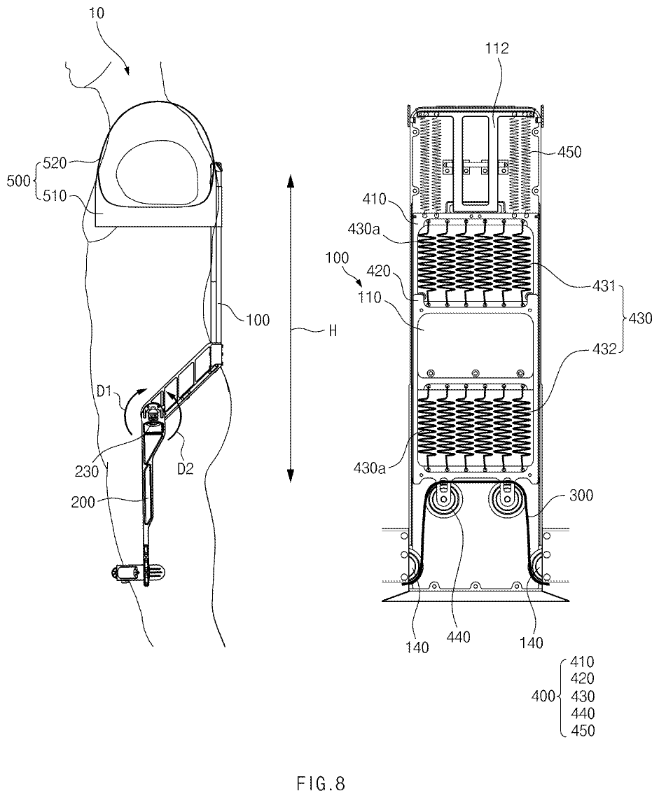

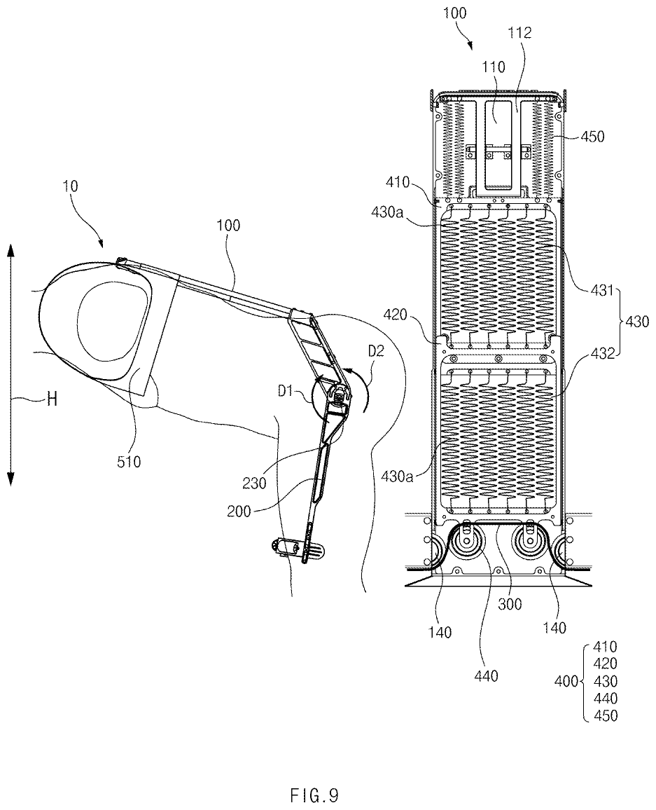

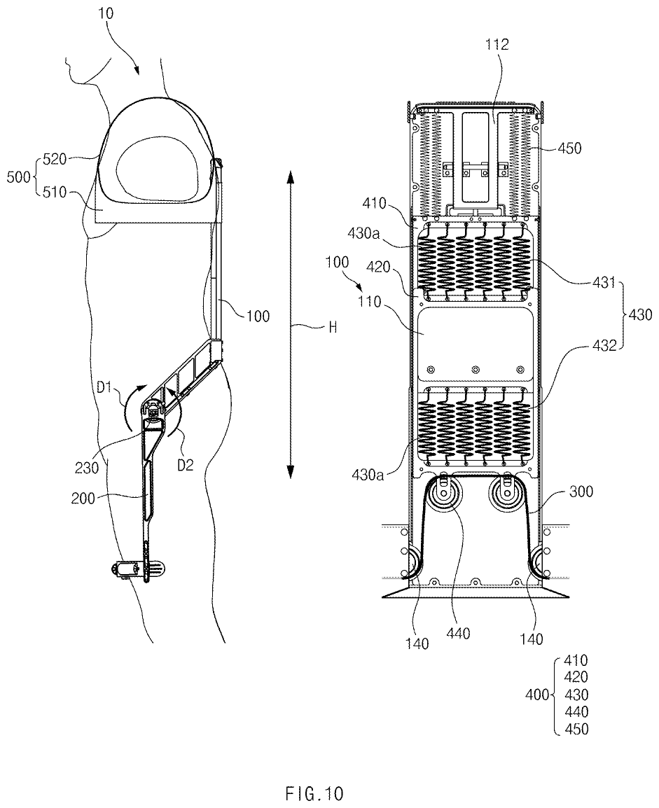

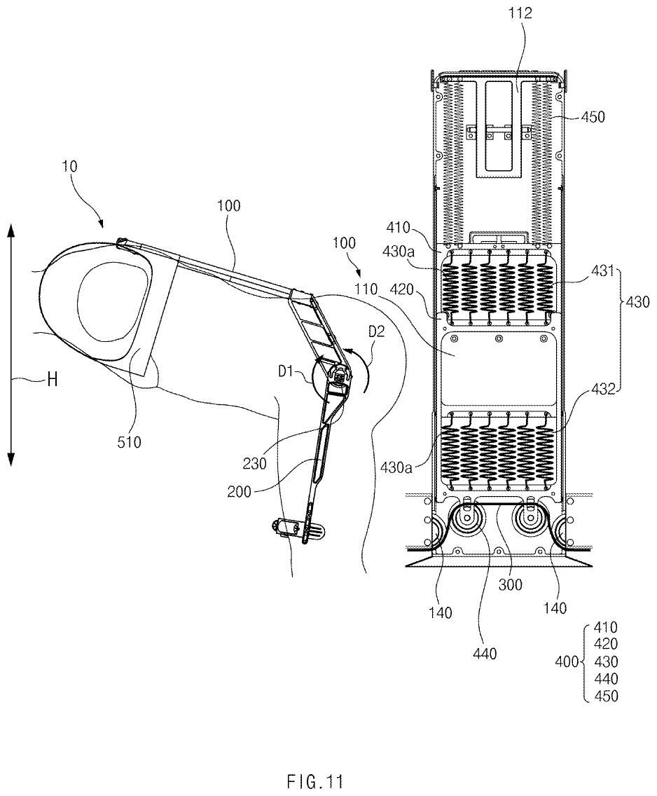

FIG. 7 is a view illustrating the relative positional relationships between the components of the force generating unit and the apparatus for assisting muscular strength before the user wears the apparatus for assisting muscular strength according to an example embodiment of the present disclosure, and FIG. 8 is a view illustrating the relative positional relationships between the components of the force generating unit and the apparatus for assisting muscular strength immediately after the user wears the apparatus for assisting muscular strength according to an example embodiment of the present disclosure. FIG. 9 is a view illustrating the relative positional relationships between the components of the force generating unit and the apparatus for assisting muscular strength when the user bends his/her waist in the state in which the user wears the apparatus for assisting muscular strength according to an example embodiment of the present disclosure, and FIG. 10 is a view illustrating the relative positional relationships between the components of the force generating unit and the apparatus for assisting muscular strength in the state in which the user wears the apparatus for assisting muscular strength according to an example embodiment of the present disclosure and the latch member and the force generating unit are disconnected from each other. In addition, FIG. 11 is a view illustrating the relative positional relationships between the components of the force generating unit and the apparatus for assisting muscular strength when the user bends his/her waist in the state in which the user wears the apparatus for assisting muscular strength according to an example embodiment of the present disclosure and the latch member and the force generating unit are disconnected from each other.

Hereinafter, a process of operating the apparatus 10 for assisting muscular strength according to an example embodiment of the present disclosure will be described with reference to FIGS. 7 to 11.

Referring to FIG. 7, the lower frame 200 may be maintained in a state in which the lower frame 200 is rotated rearward by a predetermined angle in the second direction D2 before the user wears the apparatus 10 for assisting muscular strength. Then, when the user wears the apparatus 10 for assisting muscular strength, the lower frame 200 may be rotated forward in the first direction D1, as illustrated in FIG. 8. In this case, the second pulley members 230 may also be rotated in the first direction D1 by the rotation of the lower frame 200, such that the wire 300 is wound around the second pulley members 230. Therefore, according to the exemplary embodiment, the wire 300 moves the second movable member 420 of the force generating unit 400 downward, such that the main spring part 430 is stretched. When the main spring part 430 is stretched, the tension of the wire 300 is increased by the elastic force of the main spring part 430. Therefore, the second pulley members 230 receive the force that rotates the second pulley members 230 in the second direction D2, and the lower frame 200 also receives the force that rotates the lower frame 200 in the second direction D2. These forces act as the forces that bring the lower frame 200 into close contact with the user's lower body. Then, in example embodiments, when the user bends his/her waist while the user wears the apparatus 10 for assisting muscular strength, the lower frame 200 is rotated at a larger angle in the first direction D1 relative to the upper frame 100, as illustrated in FIG. 9. Therefore, the wire 300 may be further wound around the second pulley members 230, and the degree to which the main spring part 430 is stretched is also increased. As a result, in exemplary embodiments, the force, which is applied by the wire to rotate the second pulley members 230 and the lower frame 200 in the second direction D2, is also increased. This force may be applied in the direction in which the waist is stretched in the state in which the user bends the waist. Therefore, this force may act as the force for assisting the strength of the user's waist muscles.

In an exemplary embodiment, when the user walks while the user wears the apparatus 10 for assisting muscular strength, the direction in which the right lower frame 210 rotates relative to the upper frame 100 is opposite to the direction in which the left lower frame 220 rotates relative to the upper frame 100. Therefore, in exemplary embodiments, the direction in which the second pulley member 230 disposed on the right lower frame 210 rotates is opposite to the direction in which the second pulley member 230 disposed on the left lower frame 220 rotates. Therefore, in exemplary embodiments, the force, which is applied by the wire 300 to pull the second movable member 420 downward by means of the first pulley members 440, is not changed, and the main spring part 430 is not stretched. In exemplary embodiments, the force for assisting the strength of the user's waist muscles is not additionally generated while the user walks.

Meanwhile, according to an example embodiment of the present disclosure, as illustrated in FIGS. 10 and 11, the lower frame 200 may come into close contact with the user's lower body even when the latch member 112 and the first movable member 410 are disconnected from each other.

That is, referring to the exemplary embodiment illustrated in FIG. 10, since the auxiliary spring part 450 is fixedly coupled to the upper region of the latch member 112 and the first movable member 410, the auxiliary spring part 450 may still maintain the state in which the second movable member 420 and the first pulley members 440 pull the wire 300 upward, even though the latch member 112 and the first movable member 410 are disconnected from each other. Therefore, in exemplary embodiments, the lower frame 200 still receives the force that rotates the lower frame 200 in the second direction D2, such that the lower frame 200 may be kept in close contact with the user's lower body.

In addition, as illustrated in the exemplary embodiment of FIG. 11, when the user bends his/her waist while the latch member 112 and the first movable member 410 are disconnected from each other, the auxiliary spring part 450 may be stretched by the tension of the wire 300 while the main spring part 430 is not stretched. In this case, since the elastic modulus of the auxiliary spring part 450 is remarkably smaller than the elastic modulus of the main spring part 430, the remarkably small amount of force may be applied in the second direction D2 to the second pulley members 230 or the lower frame 200 even though the auxiliary spring part 450 is stretched to a large extent. Therefore, according to an example embodiment of the present disclosure, the user may sit in a chair or on a floor without receiving the force for assisting the strength of the waist muscles in the state in which the latch member 112 and the first movable member 410 are disconnected from each other.

Meanwhile, to reconnect the latch member 112 and the first movable member 410 of the apparatus 10 for assisting muscular strength according to an example embodiment of the present disclosure, the user i) rotates the lower frame 200 rearward in the second direction D2 so that the wire 300 is unwound from the second pulley members 230 and the force, which is applied by the wire 300 to pull the second movable member 420 downward, is decreased, such that ii) the auxiliary spring part 450 is contracted, iii) the first movable member 410 is moved upward toward the latch member 112, and thus the latch member 112 and the first movable member 410 may be coupled to each other again.

The present disclosure has been described with reference to the limited embodiments and the drawings, but the present disclosure is not limited thereto. The present disclosure may be carried out in various forms by those skilled in the art, to which the present disclosure pertains, within the technical spirit of the present disclosure and the scope equivalent to the appended claims.

What is claimed is:

1. An apparatus for assisting muscular strength, the apparatus comprising:
an upper frame configured to be fixed to a user's upper body;
a lower frame disposed below the upper frame and configured to be fixed to the user's lower body and rotatable relative to the upper frame;
a wire disposed across the upper frame and the lower frame; and
a force generating unit coupled to one side of the upper frame,
wherein when the lower frame rotates in a first direction D1 relative to the upper frame, the force generating unit applies a force to the lower frame in a second direction D2 opposite to the first direction D1,
wherein the force generating unit comprises:
a first movable member configured to be movable in an upward/downward direction H;
a second movable member disposed below the first movable member and configured to be movable in the upward/downward direction H; and
a main spring part having one side fixed to the first movable member and the other side fixed to the second movable member.

2. The apparatus of claim 1, wherein the force generating unit further comprises first pulley members fixed to one side of the second movable member, and the wire extends upward from the lower frame, surrounds upper portions of the first pulley members, and then extends downward toward the lower frame.

3. The apparatus of claim 1, wherein the lower frame comprises second pulley members coupled to be rotatable relative to the upper frame, and ends of the wire are fixed to the second pulley members.

4. The apparatus of claim 3, wherein the lower frame further comprises:
a right lower frame configured to be fixed to the user's right leg; and
a left lower frame configured to be fixed to the user's left leg,
wherein the second pulley members are respectively disposed on the right and left lower frames, and
wherein one end of the wire is fixed to the second pulley member disposed on the right lower frame, and the other end of the wire, which is opposite to one end of the wire, is fixed to the second pulley member disposed on the left lower frame.

5. The apparatus of claim 4, wherein the upper frame comprises:
an up/down extension region extending in the upward/downward direction H and coupled to the force generating unit;
a right extension region extending in a right direction from a lower portion of the up/down extension region and connected to the right lower frame by means of the second pulley member; and
a left extension region extending in a left direction from the lower portion of the up/down extension region and connected to the left lower frame by means of the second pulley member.

6. The apparatus of claim 1, wherein the main spring part comprises a first main spring part having one end coupled to an upper end region of the first movable member and the other end coupled to an upper end region of the second movable member.

7. The apparatus of claim 6, wherein the main spring part further comprises a second main spring part having one end coupled to a lower end region of the first movable member and the other end coupled to a lower end region of the second movable member.

8. The apparatus of claim 7, wherein the lower end region of the first movable member is disposed between the upper end region of the second movable member and the lower end region of the second movable member.

9. The apparatus of claim 7, wherein the first main spring part or the second main spring part comprises a plurality of spring members.

10. The apparatus of claim 7, wherein an elastic modulus of the first main spring part corresponds to an elastic modulus of the second main spring part.

11. The apparatus of claim 6, wherein the up/down extension region further comprises a latch member having a lower region configured to be rotatable about an upper region of the latch member, and the lower region of the latch member is coupled to or separated from the first movable member according to a rotation of the latch member.

12. The apparatus of claim 11, wherein the first movable member comprises a recessed portion recessed in a forward/rearward direction, and the latch member comprises a protrusion configured to be inserted into the recessed portion or separated from the recessed portion according to the rotation of the latch member.

13. The apparatus of claim 11, wherein the force generating unit further comprises an auxiliary spring part having one end coupled to the up/down extension region and the other end coupled to the first movable member.

14. The apparatus of claim 13, wherein an elastic modulus of the auxiliary spring part is smaller than an elastic modulus of the first main spring part.

15. The apparatus of claim 13, wherein one end of the auxiliary spring part is coupled to an upper end of the latch member, and the other end of the auxiliary spring part is coupled to an upper end of the first movable member.

16. The apparatus of claim 4, wherein the wire surrounds a lower region of the second pulley member disposed on the right lower frame and surrounds a lower region of the second pulley member disposed on the left lower frame.

17. The apparatus of claim 11, further comprising:
a harness coupled to one side of the upper frame, wherein the harness further comprises:
a first surrounding member configured to surround the user's chest;
a plurality of second surrounding members configured to surround the user's shoulders; and
a handle member having one side configured to extend forward across the user's the shoulders and the other side connected to the upper region of the latch member, and
wherein when one side of the handle member is pulled forward, the upper region of the latch member is rotated, such that the lower region of the latch member is rotatable rearward.

18. The apparatus of claim 5, wherein the upper frame further comprises third pulley members respectively fixed to the right and left extension regions, and the wire surrounds lower regions of the third pulley members and then extends upward toward the first pulley members.

19. The apparatus of claim 1, wherein the first and second movable members each have a shape having a penetrated central region.
